(19) United States
(12) Patent Application Publication
(10) Pub. No.: US 2017/0371925 A1
(43) Pub. Date: Dec. 28, 2017

(54) QUERY DATA STRUCTURE REPRESENTATION

(71) Applicant: LinkedIn Corporation, Mountain View, CA (US)

(72) Inventors: Dhruv Arya, Sunnyvale, CA (US); Diwakar Punjani, San Mateo, CA (US); Abhimanyu Lad, San Mateo, CA (US)

(21) Appl. No.: 15/191,220

(22) Filed: Jun. 23, 2016

(51) Int. Cl. G06F 17/30

(52) U.S. Cl. CPC G06F 17/30448; G06F 17/30598; G06F 17/30289; G06F 17/30457; G06F 17/3053

(57) ABSTRACT

A system and method for generating a data structure for an input query are provided. In example embodiments, the system receives an input query comprising of a plurality of terms. A data structure is generated comprising of a root node and lower level nodes, the root node indicating choices available for the query input, the lower level nodes including a first node with a first term of the input query and a second node with a second term of the input query. The first node is mapped to a first category with a first confidence score indicating a confidence of the mapping of the first node to the first category. The second node is mapped to a second category with a second confidence score indicating a confidence of the mapping of the second node to the second category. The input query is rewritten based on the generated data structure

### TECHNICAL FIELD

Embodiments of the present disclosure relate generally to data structures and, more particularly, but not by way of limitation, to a query data structure representation.

### BACKGROUND

Query searches for document or information retrieval are particularly difficult due to the limitations in the amount of context available for the searches. Typically the user simply provides a text-based input representing the best combination of keywords the user can think of to reflect the goal of the search. Limitations in the amount of available context surrounding the query limit the ability to determine user intent behind the input query in situations where the text-based input is incomplete or otherwise would not return relevant or the most applicable results. Query intent may differ from user to user depending on their background and personal information. Further, even if user intent is somehow captured and utilized in an initial search process, this context information is lost when additional search processes are performed.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed.

FIG. 2 is a block diagram illustrating an example embodiment of a query structuring system, according to some example embodiments.

FIG. 3 is a block diagram illustrating an example data structure generated for an input query, according to some example embodiments.

FIG. 4 is a block diagram illustrating an example updated data structure generated for an second input query, according to some example embodiments.

FIG. 5 is a flow diagram illustrating an example method for generating a data structure encapsulating query understanding and query ambiguity, according to example embodiments.

FIG. 6 is a flow diagram illustrating an example method for updating a cached data structure to correspond to a second input query, according to example embodiments.

FIG. 7 is an example user interface for interactively presenting the search results with category selected highlighting, according to a ranked order, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various embodiments, a system generates a data structure for a query that captures a holistic representation of a search intent, taking into account query understanding, query rewriting, and query ranking. Such a system addresses the problems of how to capture contextual information about a search query and how to store and maintain the contextual information through multiple different search processes where such information would ordinarily be lost. The data structure is a representation of any input query and its underlying contextual information while not being tied to any particular backend structure of a search engine. As a result, the data structure is an intermediate data structure representation that allows flexibility of representing different types of information, including input query intent and personal information of the user. Further, the data structure also encompasses semantic ambiguities and synonyms inherent in the query content to improve the relevancy of query result. In an example embodiment, a data structure is generated for an input query, the data structure mapping each term of the query to a corresponding category within a database, which reflects the understanding of the term. Each term of the query comes in example form of a word or phrase that is part of the query. Each category mapped to a term of the query is assigned a confidence score representing the certainty in the assignment. In other words, the confidence score reflects the confidence of the system in determining that the term belongs to that mapped category. Each word or phrase may be mapped to every possible interpretation along with a corresponding confidence score of such interpretations, each interpretation being the category being mapped to the term. Additionally, the data structure also includes synonyms that are determined for each word of phrase.

Based on the confidence scores, the query can then be rewritten in a format that can be processed by a backend search engine. Based on the confidence score and the query as rewritten, the rewritten query can be sent to a search engine for document retrieval, and the retrieved search results can be ranked accordingly. As a result, query understanding, rewriting and ranking are not determined independently of each other, but rather the ranking is aware of the conditions involved in the query rewriting and the query understanding. Thus, each part of the query are represented in a holistic manner within a data structure, such that the data structure represents the user's intent, all query parameters, all categories represented within the query, and the relations between the mapped categories, making all of this information available for use through the disparate document retrieval, rewriting, and ranking processes.

In various embodiments, the terms within the query are highlighted in the search results. The highlighting is limited to the associated categories of the assigned query words, rather than a general highlighting of all matches within the document. In other words, the search results are presented in a category selected highlighting, where the highlighting includes various ways to call attention to the terms in the search results that matches the terms in the query. Highlighting comes in the form of bold, italicize, underlined, larger text, color highlighting, and the like). Category selected highlighting refers to terms within the specific category would be highlighted, whereas if the terms appear outside of the category field, it would not be highlighted. For instance, within a search query for “software engineer,” the data structure maps the phrase “software engineer” to a job title category within the data structure. As a result, during the presentation of the search result, the phrase “software engineer” is only highlighted if it appears within the job title field of the user's member profile. If the phrase “software engineer” appears anywhere else, such as a description field of a job function, then it does not get highlighted.

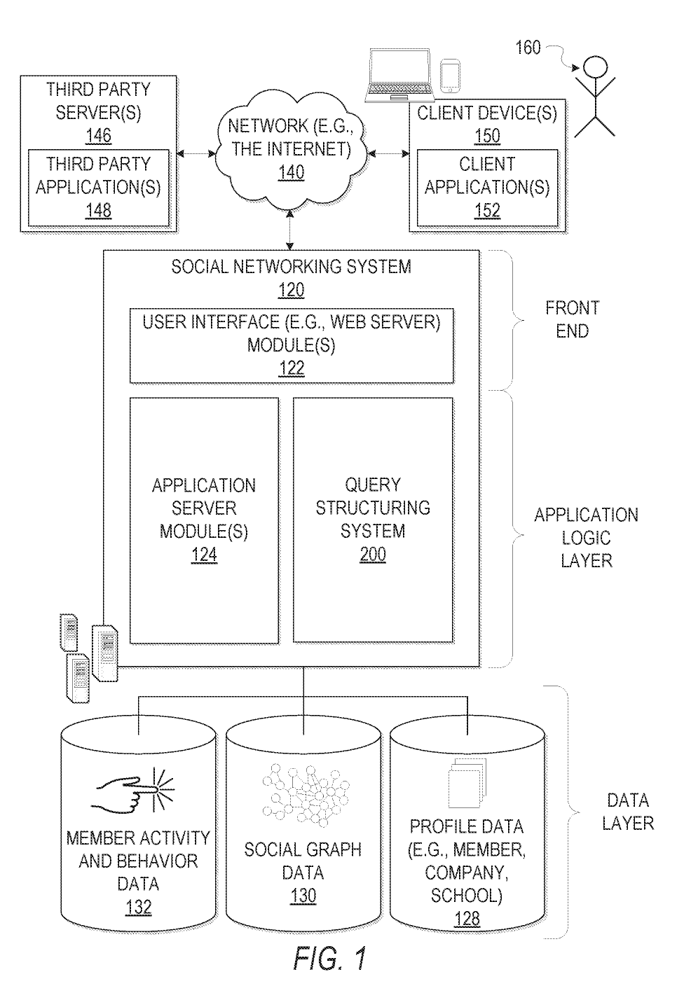

As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, Application Programming Interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone). For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132. The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include a query structuring system 200, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

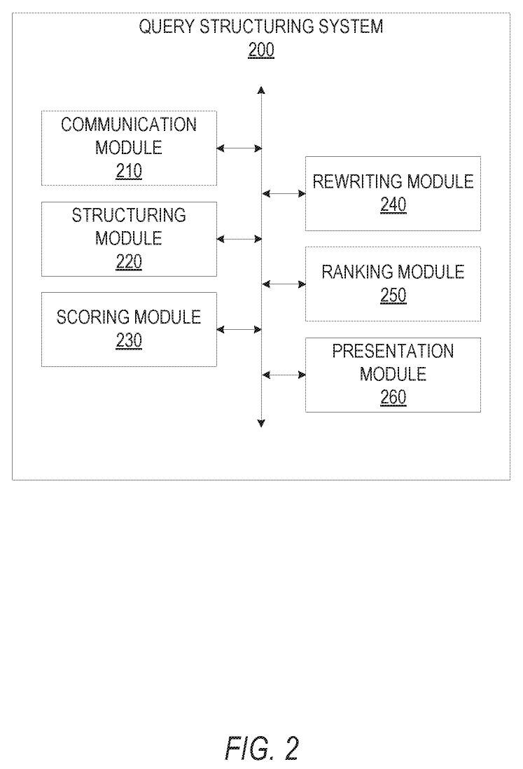

FIG. 2 is a block diagram illustrating components provided within the query structuring system 200, according to some example embodiments. The query structuring system 200 includes a communication module 210, a structuring module 220, a scoring module 230, a rewriting module 240, a ranking module 250, and a presentation module 260. The query structuring system 200 generates a data structure representation comprising of the relationships of each process within the query retrieval process. This data structure is in contrast with other structures that send information associated with the input query along in a piecemeal process, where the relationships within each process of the query retrieval process are lost. The query retrieval process includes 1) query understanding, where the system attempts to determine what the user intends to find by mapping each interpretation of the query to its corresponding category, 2) query rewriting, where the input query is rewritten to match the backend database in order to allow for correct document retrieval, and 3) ranking, where the documents are ranked in the most relevant order. Furthermore, the data structure is able to represent and accommodate for semantic ambiguities and synonyms that arise within the search query. As a result, the data structure captures a holistic representation of a search intent, taking into account query tagging, query rewriting, and query ranking. All, or some, of the modules are configured to communicate with each other, for example, via a network coupling, shared memory, a bus, a switch, and the like. It will be appreciated that each module may be implemented as a single module, combined into other modules, or further subdivided into multiple modules. Any one or more of the modules described herein may be implemented using hardware (e.g., a processor of a machine) or a combination of hardware and software. Other modules not pertinent to example embodiments may also be included, but are not shown.

The communication module 210 is configured to perform various communication functions to facilitate the functionality described herein. For example, the communication module 210 may communicate with the social networking system 120 via the network 140 using a wired or wireless connection. The communication module 210 may also provide various web services functions such as retrieving information from the third party servers 146 and the social networking system 120. In this way, the communication module 210 facilitates the communication between the query structuring system 200 with the client devices 150 and the third party servers 146 via the network 140. Information retrieved by the communication module 210 may include profile data corresponding to the user 160 and other members of the social network service from the social networking system 120.

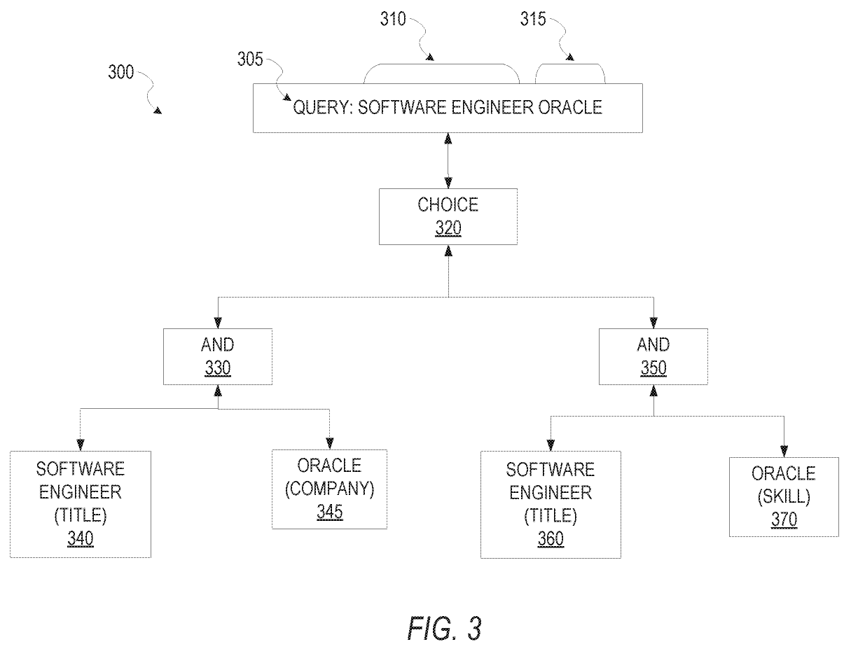

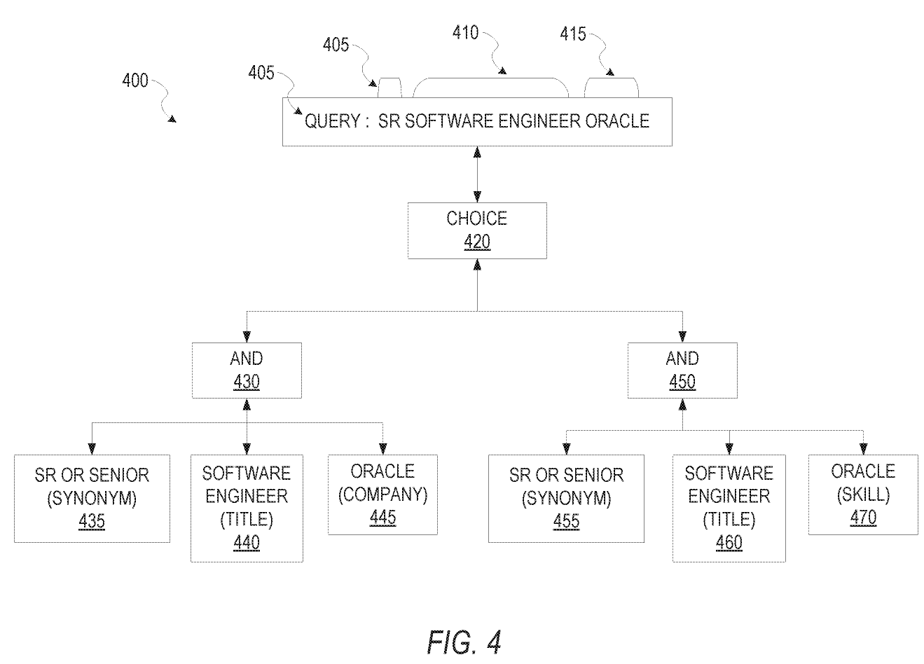

The structuring module 220 is configured to generate, from an input query, a data structure that captures the category mapping of the terms within the input query, the relationships between the categories, thereby encompassing the subcategory relationships existing within the categories that the terms are mapped to. For instance, in an input query of “software engineer,” the term “software engineer” is mapped to the category job title within the database 128. Within database 128, there is a hierarchy of subcategories within categories that further define the categories. For example, within the category of “software engineer,” there are subcategories determining the job function, seniority level, other related job titles, and the like. Each category and subcategories are associated with an identification number (ID) for ease of mapping between the generated data structure representation of the query to the backend data structure within the database 128 or other databases such as database 132 and database 130. The mapping of an input query to its corresponding categories are further discussed in detail with respect to FIG. 3 and FIG. 4.

In various embodiments, the generated data structure also encapsulates semantic ambiguity and synonyms inherent within the input query. Within short queries, there is often not enough surrounding context to determine the correct choice when it comes to several interpretations of a single word. As a result, the data structure may represent such ambiguities and synonyms by representing the query in all its possible interpretations. Each interpretation of an ambiguity is associated with a confidence score calculated by the scoring module 230, as discussed in further detail below. The data structure representation of ambiguities and synonyms are further discussed in detail with respect to FIG. 3 and FIG. 4.

In various embodiments, the generated data structure is cached for subsequent retrieval and use. Data structure of frequently used query searches are cached for use by other users so that the same input query does not necessitate the redundant process of generating the same data structure for the same input query each time the input query is entered by other users. In some embodiments, the data structure is cached without the personalized information associated with the user. Where the generated data structure include some personal information associated with the user that enters the input query, the cached data structure would eliminate any personal information associated with such user.

In various embodiments, the data structure allows for easy changes within the data structure, such as adding in more information, deleting certain information, or changing existing information within the data structure. For instance, where the user types in the input query “software engineer Oracle,” and then subsequently adds in “senior” before the query “software engineer Oracle,” the data structure simply adds in another node for the addition of “senior” within the data structure associated with the input query “software engineer Oracle.” As a result, the data structure allows for easy addition, deletion, or changes within an existing query.

The scoring module 230 is configured to determine a confidence score associated with each possible interpretation of the input query. An input query may have inherent semantic ambiguities and synonyms associated to some of the terms within the query. The data structure encapsulates all possible interpretations of the existing ambiguities and synonyms and assign a confidence score associated with each possible interpretation. The confidence score indicating the accuracy in which the system maps each term to a corresponding category. For instance, an input query of “software engineer oracle,” the system looks at every term within the query an assigns the term to a category (e.g., in affect assigned a meaning to the term). In this instance, “software engineer” is assigned an ID which corresponds to the category job title within database 128. The term “Oracle” is determined to have two interpretations, and thus an ambiguity exist. Thus, the data structure encompasses both choices present for the term “Oracle.” The first choice is Oracle the company and the second choice is Oracle the skill set. As a result, the system assigns the term “Oracle” to the category company with a confidence score of 75% and also assigns it to the category skill set with a confidence score of 25%. The confidence score is calculated based on machine learning models of two types of training data set, including past activities of all members from database 132 and the profile data of all members on the database 128.

In various embodiments, in determining the confidence score associated with the mapping of a term within an input query to a specific category, the scoring module 230 uses member activity and behavior data obtained from database 132. The confidence score is calculated based on member activity data indicating a percentage of member activity associating the term to the corresponding category. For instance, member activities and behavior include statistics of when users type in the same terms as input query and the corresponding percentage in which the users then click on search results with one of the interpretations of the known ambiguity. Continuing with the previous example, when users input a search query with the term Oracle, the scoring module 230 determines that 75% of the time, the users then click on search results that specify Oracle as the company rather than Oracle the skill. In this instance, the confidence score of assigning the category company to the term Oracle is 0.75.

In other embodiments, in determining the confidence score associated with assigned a term within an input query to a specific category, the scoring module 230 uses profile data of members obtained from database 128. The confidence score is calculated based on member profile data indicating a percentage of member profile data associating the term to the corresponding category. For instance, statistics are determined from member profiles in order to determine the category in which the term can be found. Continuing with the previous example, the scoring module 230 determines that 25% of the profiles within database 128 indicate that Oracle is a skill set. In this instance, the confidence score of assigning the category skill set to the term Oracle is 0.25. In other embodiments, the confidence score is calculated based on both member activity data and member profile data.

In various embodiments, based on the generated data structure, the rewriting module 240 is configured to rewrite the input query in a format that can be processed by a search engine. From the example given above, based on the data structure with the corresponding confidence score, the input query of “software engineer Oracle” can be rewritten as: (Title (software engineer” AND company (Oracle) documents [750]) OR (Title (software engineer” AND skill (Oracle) documents [250]). Where the input query did not specify the category of each term, the rewritten query tags each term with its determined category. The rewritten query includes all interpretations available to the input query by tagging the ambiguous term Oracle with both categories of company and skill. In some embodiments, the confidence score is used by the rewriting module 240 to restrict the amount of results being retrieved from the database 128. The amount of document retrieval is weighted by the confidence score percentage such that the number of results are multiplied by the confidence percentage. For instance, continuing from the example above, a confidence score of 75% associated with assigning company category to Oracle term is used to restrict the document search to 750 documents out of 1000, where the skill Oracle is restricted to 250 documents. In other words, the amount of results is restricted based on the confidence score, where company Oracle is restricted to 750 document matches and skill Oracle is restricted to 250 document matches. Therefore, the retrieval ratio between the two different choice is based on the confidence score.

In some embodiments, the rewritten query is presented to the user and the user may alter the input query to clarify the ambiguity. In some embodiments, any clarification added by the user subsequent to the initial query is added to the existing generated data structure. For instance, continuing with the above example, the user's initial query is “software engineer oracle.” Subsequently, after a search result is returned for that initial query, the user may add in the term “company” resulting in the second query “software engineer oracle company” to clarify the ambiguity between oracle the skill or oracle the company. In response, the generated data structure is updated to incorporate a confidence score associated with oracle company to be 100% while the confidence score associated with oracle skill is updated to be 0% with the subsequent user clarification. In other embodiments, a new data structure is generated for subsequent clarification added to the query by the user.

In various embodiments, the ranking module 250 is configured to rank the retrieved documents in an order of relevance based on the match of the input query to the information within a document, personal information within the member profile of the user, and information pertaining to the professional network of the user. Each factor that influences the ranking order of the retrieved documents have an associated predetermined weight with the document scoring higher based on these predetermined weights being ranked higher. For example, first connections are weighted more than second connections, and so forth, where a first connection refers to the user being directly connected to the second member profile. A second connection refers to the user being directly connect to another member profile who is then directly connected to the second member profile. In another example, member profiles that share similarities with the user's profile is weighted more than other member profiles that have less similarities.

In some implementations, the presentation module 260 is configured to present query rewriting recommendations to the user, present search results according to its ranked order, present a reason associated with why the query result is being presented (e.g., such as a shared connection), and present the search results with category selected highlighting. In some embodiments, where there are ambiguities associated with a term, the interpretation associated with retrieving a result is shown to the user. In various implementations, the presentation module 260 presents or causes presentation of information (e.g., visually displaying information on a screen, acoustic output, haptic feedback). Interactively presenting information is intended to include the exchange of information between a particular device and the user of that device. The user of the device may provide input to interact with a user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 260 provides many other user interfaces to facilitate functionality described herein. Further, it will be appreciated that “presenting” as used herein is intended to include communicating information or instructions to a particular device that is operable to perform presentation based on the communicated information or instructions via the communication module 210, structuring module 220, scoring module 230, rewriting module 240, and ranking module 250.

FIG. 3 is a block diagram illustrating an example data structure 300 generated for an input query 305, which includes term 310 and term 315. The structuring module 220 looks at every term in the input query 305 and assigns a category to each term. Each category has an ID number that maps to the categories within the database 128, where the categories include a taxonomy data structure with metadata included within the categories. For instance, a category of job title includes job function, required education, seniority, and the like. The structuring module 220 determines the input query 305 includes term 310 “software engineer” and term 315 “oracle.” The data structure 300 begins with a root node indicating a choice operator 320 encompassing all different interpretations of the input query 305. The parent node 330 shows one interpretation of the input query 305. The parent node 330 and 350 includes the condition operator “and”. Depending on the query, the condition operator of the parent nodes may change, these condition operator include, but not limited to, “and”, “or”, and the like. The child node 340 includes the term “software engineer” 310 being mapped to the category of job title and assigned a category identifier 1441 with a determined confidence score 0.99. The child node 345 includes the term “oracle” 315 being mapped to the category of company and assigned a category identifier 131 with a determined confidence score of 0.75. The child node 360 includes the term “software engineer” 310 being mapped to the category of job title and assigned a category identifier 1441 with a determined confidence score 0.99. The child node 370 includes the term “oracle” 315 being mapped to the category of skill set and assigned a category identifier 112 with a determined confidence score of 0.25. As a result, the first interpretation of the input query includes the job title “software engineer” 340 and the company “oracle” 345. The second interpretation of the input query includes the job title “software engineer” 360 and the skill set “oracle” 370, where each category is mapped to a corresponding data structure within database 128 for subsequent searching.

In various embodiments, the generated data structure 300 is cached for later use where another user input the same query. In some embodiments, to save database space, where the input query is used above a threshold amount of time, its corresponding data structure is cached. It is noted that while the data structure is being depicted in a tree format, the data structure can actually be stored in any format as long as the relevant information and the relationships between the information pieces is maintained. For example, this tree structure could easily be stored as a record with the record containing fields having pointers to related fields.

FIG. 4 is a block diagram illustrating an example data structure 400 generated for an input query 405. In some embodiments, where some of the input query have been cached, the data structure for that corresponding may be retrieved and any additional query terms are added to the data structure. For instance, the terms “software engineer oracle” was cached from an input query 305. The corresponding data structure 300 is retrieved and the additional query term “sr” 405 is added to the data structure with the corresponding child node 435 and 455. In other embodiments, the structuring module 220 can generate the whole data structure 400 where there are usable cached data structure.

In various embodiments, the structuring module 220 determines the input query 405 includes term 410 “software engineer” and term 415 “oracle.” The data structure 400 begins with a root node indicating a choice operator 420 encompassing all different interpretations of the input query 405. The parent node 430 and 450 includes the condition operator “and”. The child node 440 includes the term “software engineer” 410 being mapped to the category of job title and assigned a category identifier 1441 with a determined confidence score 0.99. The child node 445 includes the term “oracle” 415 being mapped to the category of company and assigned a category identifier 131 with a determined confidence score of 0.75. The child node 435 includes the term “sr” 405 and the synonym senior. The node indicates that the data structure treats the term “sr” 405 and same as “senior” during the search based on a determination that the terms “sr” and “senior” are synonyms. The nodes 435 and 455 are mapped to a level category in the database 128 with a determined confidence score of 0.98. The child node 460 includes the term “software engineer” 410 being mapped to the category of job title and assigned a category identifier 1441 with a determined confidence score 0.99. The child node 370 includes the term “oracle” 415 being mapped to the category of skill set and assigned a category identifier 112 with a determined confidence score of 0.25. The child node 445 includes the term “sr” 405 and the synonym senior. As a result, the first interpretation of the input query includes the level “sr” or “senior” 435, job title “software engineer” 440, and the company “oracle” 445. The second interpretation of the input query includes the level “sr” or “senior” 455, job title “software engineer” 460, and the skill set “oracle” 470, where each category is mapped to a corresponding data structure within database 128 for subsequent searching.

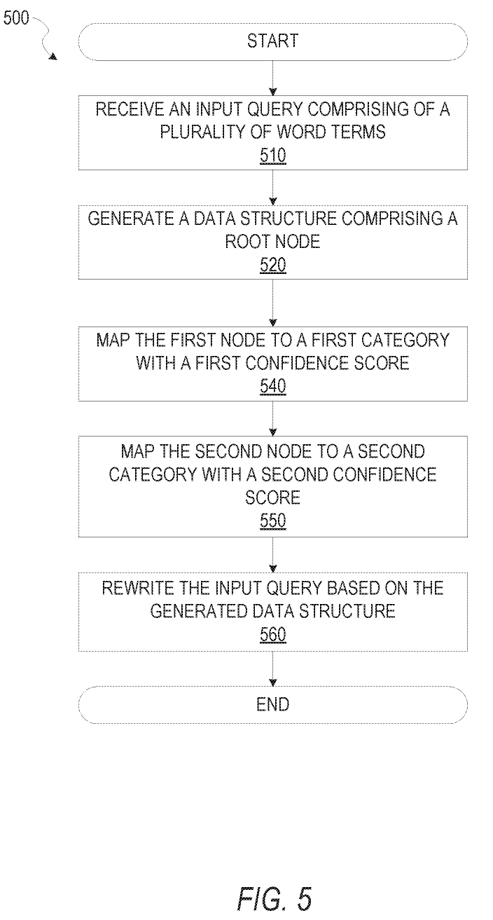

FIG. 5 is a flow diagram illustrating an example method 500 for generating a data structure encapsulating query understanding and query ambiguity, according to example embodiments. The operations of the method 500 may be performed by components of the query structuring system 200. At operation 510, the query structuring system 200 receives an input query comprising a plurality of terms from a user. For instance, the user may be searching or a job position an enters in the search field the input query “software engineer oracle.” The structuring module 220 processes the input query and determines the terms based on a comparison of the input query to database 128 for match terms. Terms includes a single-word term or a multi-word phrase, a single-word term can be in the example form of a single word such as “engineer” and a multi-word phrase can be in example form of multiple words such as “software engineer”.

At operation 520, the structuring module 220 generates a data structure using the terms. The data structure includes a root node indicating choices available for the query input. Referring back to the example in FIG. 3, the root node 320, shows the available choices between the lower level nodes 330 and 350. the data structure can further include lower level nodes including a first node with a first term of the input query and a second node with a second term of the input query. Referring back to the example in FIG. 3, lower level nodes further includes the first choice of software engineer 340 and 330 company oracle 345. The second choice include lower level nodes of software engineer title 360 and 350 and skill set oracle 370.

At operation 540, the structuring module 220 maps the first node to a first category with a first confidence score indicating a confidence of the mapping of the first node to the first category. Referring back to the example in FIG. 3, the first node is oracle 345 being mapped to the first category of a company. This company category may also be a node of a second data structure within the database 128, where it has further metadata to describe and associate the company category of oracle. These metadata details include the size of the company, the employees that are current members of the professional social networking system 120, and the like. The mapping of the term oracle to the category company is assigned a confidence score which reflects the certainty to the assignment of oracle to the category company. In this instance, the confidence score is assigned 0.75. The first category is a first interpretation of the term oracle, where there is a 75% confidence that the term oracle in the query is referring to the company. Of course, the first node may also be mapped to additional categories, as depicted in FIGS. 3 and 4, along with confidence scores for each of those additional categories. Further details for confidence score calculation is discussed in association with FIG. 2.

At operation 550, the structuring module 220 maps the second node to a second category with a second confidence score indicating a confidence of the mapping of the second node to the second category. Referring back to the example in FIG. 3, the second node is oracle 370 being mapped to the second category of a skill set. This skill category is also be a node of the second data structure within the database 128. The mapping of the term oracle to the category skill is assigned a second confidence score which reflects the certainty to the assignment of oracle to the category skill. In this instance, the confidence score is assigned 0.25. The second category is a second interpretation of the same term oracle, where there is a 25% confidence that the term oracle in the query is referring to the skill set. The term software engineer, node 340 and 360, is mapped to the category title with a confidence score of 0.99. A high confidence score above a threshold indicates that this term is not ambiguous. Of course, the second node may also be mapped to additional categories, as depicted in FIGS. 3 and 4, along with confidence scores for each of those additional categories.

At operation 560, the rewriting module 240 rewrites the input query based on the generated data structure where the rewritten input query is in a format compatible to a search engine. The rewritten input query is sent to the search engine and used to retrieve search results. Referring back to the above example, the input query “software engineer oracle” from the generated data structure shown in FIG. 3 is rewritten into the format (Title (software engineer” AND company (Oracle) documents [750]) OR (Title (software engineer” AND skill (Oracle) documents [250])) as fully described in detail in association with FIG. 2 in associated with the rewriting module 240.

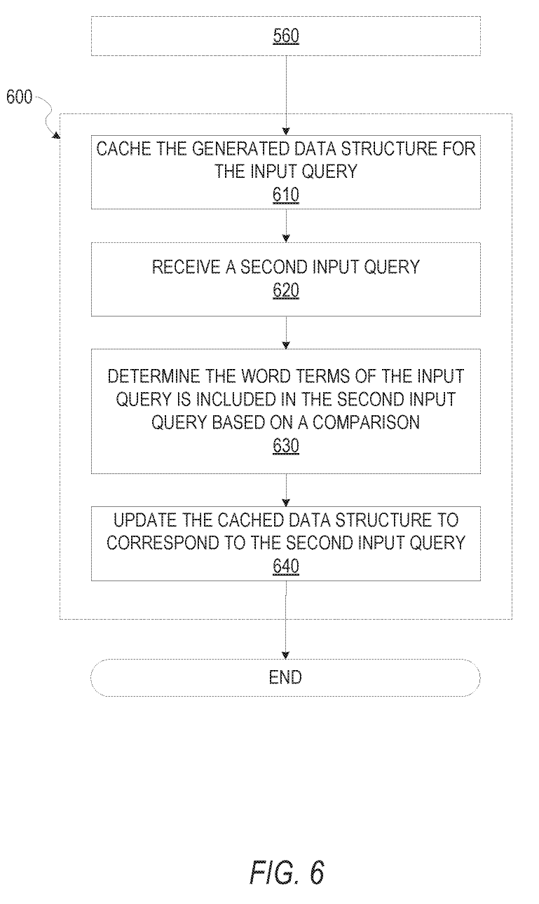

FIG. 6 is a flow diagram illustrating an example method 600 for updating a cached data structure to correspond to a second input query, according to example embodiments. The operations of the method 600 may be performed by components of the query structuring system 200. At operation 610, the structuring module 220 caches the generated data structure for the input query. Continuing on with the examples from FIG. 3 and FIG. 4, the generated data structure from the input query of “software engineer oracle” 305 in FIG. 3 is cached in a database, this input query being now referred to the first input query. At operation 620, the query structuring system 200 receives a second input query. For instance, the same or another member inputs into a search field the second input query of “sr software engineer oracle” 405 as shown in FIG. 4.

At operation 630, the structuring module 220 determines the terms of the first input query is included in the second input query based on a comparison of the first input query and the second input query, the second input query including additional terms not present in the first input query. Continuing with the previous example, the structuring module 220 compares the first input query “software engineer oracle” and the second input query “sr software engineer oracle” and determines a match of the query terms “software engineer oracle”. The structuring module 220 retrieves the first data structure cached from the first input query “software engineer oracle” (e.g., the data structured generated as shown in FIG. 3) and updates the first data structure to accommodate for the additional or different terms in the second input query. As shown in FIG. 4, the additional nodes 435 and 455 correspond to the additional term “sr” 405, where the remaining data structure are similar to the cached data structure from FIG. 3, corresponding to the remaining input query of “software engineer oracle.”

At operation 640, the structuring module 220 updates the cached data structure to correspond to the second input query, the updating including adding additional lower level nodes that include the additional terms being mapped to corresponding categories along with corresponding confidence scores. Nodes 435 and 455 are mapped to a level category with a determined confidence score of 0.98. In such a case of high confidence score, there is no ambiguity with such a mapping of the node 435 and 455 to the level category.

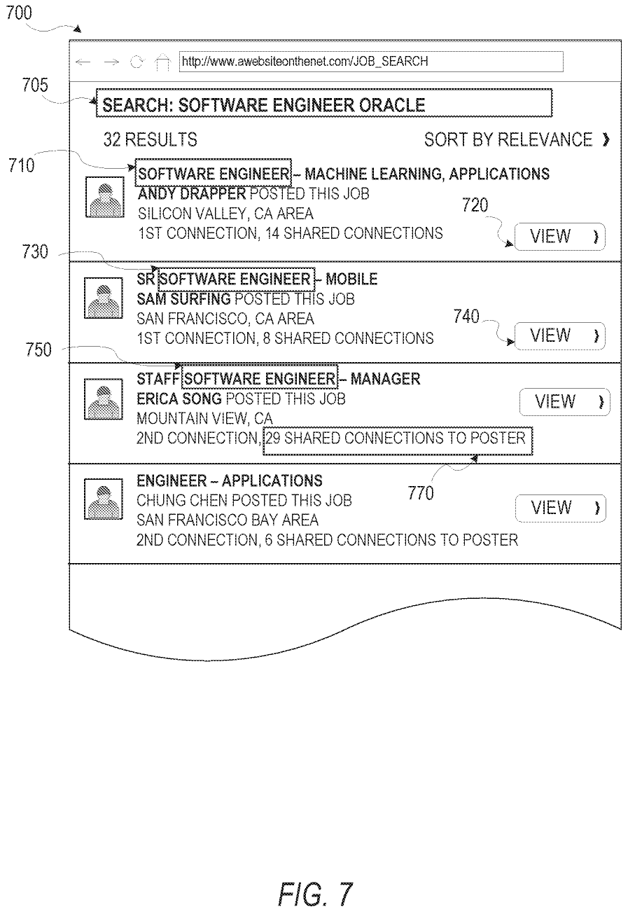

FIG. 7 is an example user interface 700 for interactively presenting the search results with category selected highlighting, according to a ranked order. Within the search results presented, terms of the search appearing in the category that was used during the search is highlighted. In the case of the example in FIG. 3 and FIG. 4, the term “software engineer” being mapped to the category skill and category company would result in the term being highlighted only when the term “software engineer” appears in the mapped category of either skill or company. The user may hover over the highlighted term to show which category, where there is an ambiguity. From the search input query 705 of “software engineer oracle,” the results are of the term “software engineer” are highlighted at term 710, 730, and 750. If the term “software engineer” is not associated with the category job title, then it is not highlighted. The link with associated text “29 shared connections to poster” 770 is also highlighted to show that the search terms of “software engineer oracle” also shows up in the landing page where the user clicks on the link 770.

In various embodiments, the presentation module 260 uses the confidence scores to associate a term with a mapped category to determine which terms to highlight. Using a predetermined confidence threshold (a confidence score threshold hold), where in response to the confidence score (e.g., the confidence score that maps a term to a category) transgresses a predetermined confidence threshold, the presentation module 260 highlights the term shown in the search results, where the term appears within the corresponding mapping category. For instance, a predetermined confidence threshold is set to be 80%, if the confidence score of mapping the term “oracle” to the category “company” is above 80%, then where all the terms “oracle” being within the category company within a search result is highlighted. Such highlighting draws attention to the links that would be of more interest to the user to select. The user map select selectable interfaces 720 and 740 to further view the corresponding job posts. It is noted that highlighting may be in the form of calling attention to the specific terms, such as bold, italicize, underlined, larger text, highlighting the terms in a specific color, changing font size and font format, and the like.

### Modules, Components, and Logic

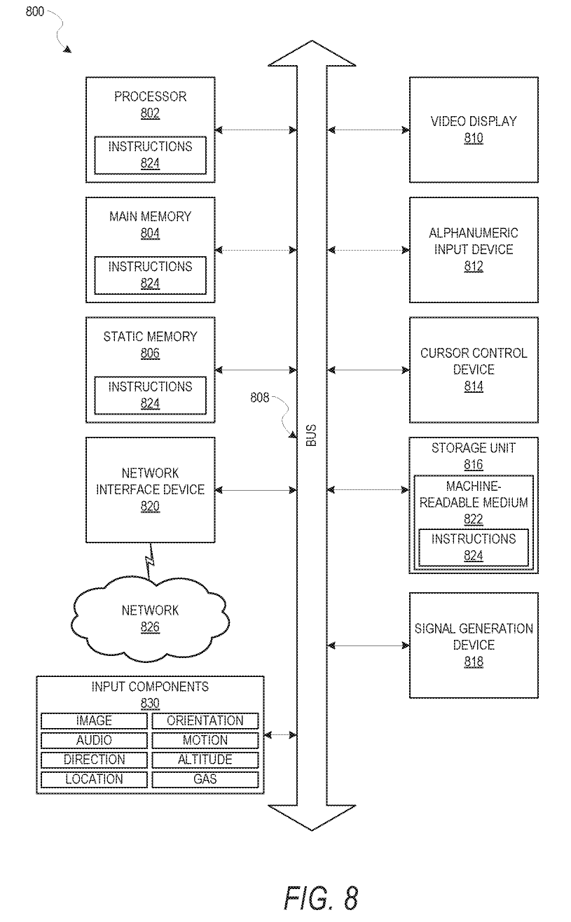

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies, associated with the query structuring system 200, discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Any of these machines can execute the operations associated with the query structuring system 200. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered as machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., WiFi and BlueTooth networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a processor, and a memory including instructions, which when executed by the processor, cause the processor to:
receive an input query comprising of a plurality of terms;
generate a data structure comprising:
a root node indicating choices available for the query input; and
lower level nodes including a first node with a first term of the input query and a second node with a second term of the input query;
a mapping of the first node to a first category with a first confidence score indicating a confidence of the mapping of the first node to the first category; and
a mapping of the second node to a second category with a second confidence score indicating a confidence of the mapping of the second node to the second category; and
rewrite the input query based on the generated data structure.

2. The system of claim 1, wherein:
the first category and second category are nodes of a second data structure.

3. The system of claim 1, wherein:
the rewritten input query is in a format compatible to a search engine.

4. The system of claim 1, further comprising:
caching the generated data structure for the input query;
receiving a second input query;
determining the terms of the input query is included in the second input query based on a comparison of the input query and the second input query, the second input query including additional terms not present in the input query;
updating the cached data structure to correspond to the second input query, the updating including adding additional lower level nodes that include the additional terms being mapped to corresponding categories along with corresponding confidence scores.

5. The system of claim 1, wherein:
the first category is a first interpretation of a term; and
the second category is a second interpretation of the term.

6. The system of claim 1, wherein:
the first confidence score is calculated based on member activity data indicating a percentage of member activity associating the first term to the first category; and
the second confidence score is calculated based on member activity data indicating a percentage of member activity associating the second term to the second category.

7. The system of claim 1, wherein:
the first confidence score is calculated based on member profile data indicating a percentage of member profile data associating the first term to the first category; and
the second confidence score is calculated based on member profile data indicating a percentage of member profile data associating the second term to the second category.

8. The system of claim 1, further comprising:
retrieving search results using the rewritten query.

9. A method comprising:
using one or more computer processors:
receiving an input query comprising of a plurality of terms from a user;
generating a data structure comprising:
a root node indicating choices available for the query input;
lower level nodes including a first node with a first term of the input query and a second node with a second term of the input query;
a mapping of the first node to a first category with a first confidence score indicating a confidence of the mapping of the first node to the first category; and
a mapping of the second node to a second category with a second confidence score indicating a confidence of the mapping of the second node to the second category; and
rewriting the input query based on the generated data structure.

10. The method of claim 9, wherein:
the first category and second category are nodes of a second data structure.

11. The method of claim 9, wherein:
the rewritten input query is in a format compatible to a search engine.

12. The method of claim 9, further comprising:
caching the generated data structure for the input query;
receiving a second input query;
determining the terms of the input query is included in the second input query based on a comparison of the input query and the second input query, the second input query including additional terms not present in the input query;
updating the cached data structure to correspond to the second input query, the updating including adding additional lower level nodes that include the additional terms being mapped to corresponding categories along with corresponding confidence scores.

13. The method of claim 9, further comprising:
the first category is a first interpretation of a term; and
the second category is a second interpretation of the term.

14. The method of claim 9, wherein:
the first confidence score is calculated based on member activity data indicating a percentage of member activity associating the first term to the first category; and
the second confidence score is calculated based on member activity data indicating a percentage of member activity associating the second term to the second category.

15. The method of claim 9, further comprising:
the first confidence score is calculated based on member profile data indicating a percentage of member profile data associating the first term to the first category; and
the second confidence score is calculated based on member profile data indicating a percentage of member profile data associating the second term to the second category.

16. The method of claim 9, further comprising:
retrieving search results using the rewritten query.

17. A machine-readable medium not having any transitory signals and storing instructions that, when executed by at least one processor of a machine, cause the machine to perform operations comprising:
receiving an input query comprising of a plurality of terms from a user;
generating a data structure comprising:
a root node indicating choices available for the query input; and
lower level nodes including a first node with a first term of the input query and a second node with a second term of the input query;
a mapping of the first node to a first category with a first confidence score indicating a confidence of the mapping of the first node to the first category; and
a mapping of the second node to a second category with a second confidence score indicating a confidence of the mapping of the second node to the second category; and
rewriting the input query based on the generated data structure.

18. The machine-readable medium of claim 17, wherein the operations further comprise:
caching the generated data structure for the input query;
receiving a second input query;
determining the terms of the input query is included in the second input query based on a comparison of the input query and the second input query, the second input query including additional terms not present in the input query;
updating the cached data structure to correspond to the second input query, the updating including adding additional lower level nodes that include the additional terms being mapped to corresponding categories along with corresponding confidence scores.

19. The machine-readable medium of claim 17, wherein:
the first category is a first interpretation of a term; and
the second category is a second interpretation of the term.

20. The machine-readable medium of claim 17, wherein:
the first confidence score is calculated based on member activity data indicating a percentage of member activity associating the first term to the first category; and
the second confidence score is calculated based on member activity data indicating a percentage of member activity associating the second term to the second category.
